(19) United States
(12) Patent Application Publication
(10) Pub. No.: US 2013/0013705 A1
(43) Pub. Date: Jan. 10, 2013

(54) IMAGE SCENE RECOGNITION

(75) Inventors: Steven W. White, Plano, TX (US); Ashok Ramadass, Allen, TX (US)

(73) Assignee: IMAGE VISION LABS, INC., Plano, TX (US)

(21) Appl. No.: 13/544,814

(22) Filed: Jul. 9, 2012

Related U.S. Application Data
(60) Provisional application No. 61/571,901, filed on Jul. 8, 2011.

(51) Int. Cl. G06F 15/16

(52) U.S. Cl. 709/206

(57) ABSTRACT

A method for filtering content with a communication device includes, with the communication device, applying a filter function to a message associated with the communication device, the filter function finding at least one content element. The method further includes comparing the content element with a set of restricted content elements, and withholding the message from communication in response to determining that the content element matches one of the restricted content elements.

### CLAIM OF PRIORITY

The present application claims priority under 35 U.S.C. §119(e) to U.S. Provisional patent application having Ser. No. 61/571,901 filed Jul. 8, 2011, the entire contents of which are incorporated herein by reference.

### BACKGROUND

Various types of content are communicated through a wide variety of means. For example, text, images, audio clips, and video clips are often sent by text message, email, or through other applications. In some cases, content may be communicated to a recipient who does not wish to view particular types of content. For example, some people wish to avoid seeing various types of graphic images. Alternatively, some people wish to avoid reading certain words that are deemed inappropriate. In some cases, a parent may wish to prevent his or her child from viewing specific types of content deemed inappropriate for that child's age group.

### SUMMARY

According to certain illustrative embodiments, a method for filtering content with a communication device includes, with the communication device, applying a filter function to a message associated with the communication device, the filter function finding at least one content element. The method further includes comparing the content element with a set of restricted content elements, and withholding the message from communication in response to determining that the content element matches one of the restricted content elements.

In some examples, the message is being received by the communication device from a second communication device. The method may further include providing a user of the communication device with an alternate message indicating a sender of the message. The alternate message may further indicate to the recipient a category associated with the one of the restricted content elements. The method may further include receiving input from the user, the input electing to allow delivery of the message. The method may also include automatically sending a reply message to a sender of the message, the reply message indicating that the message includes restricted content.

The method may further include sending a notification message to a chaperone of the communication device, the notification message indicating to the chaperone the restricted content element. The method may further include receiving an allowance. The message may be edited by the chaperone before being allowed communication.

The method may further include replacing the restricted content element within the message to an approved replacement element for the restricted content element. The restricted content elements within the set of restricted content elements may be based on preferences set for a user of the communication device.

In some examples, the message is being sent by the communication device to a second communication device. In some examples, applying the filtering function comprises analyzing an image to look for text within the image.

According to certain illustrative embodiments, a server system includes a processor and a computer readable medium. The computer readable medium comprises processor executable instructions to cause the server to receive a message from a first communication device, the message to be sent to a second communication device, compare a content element within the message with a set of restricted content elements, and withhold the message from the second communication device in response to finding a match between the content element and one of the restricted content elements.

The message may include one of: a Short Message Service (SMS) message, a Multimedia Messaging Service (MMS) message, and an email message and the content element comprises at least one of: a text string, an image, an audio file, and a video file. The set of restricted content elements may be divided into sub-sets corresponding to categories, the categories including at least sex, violence, language, drug use.

According to certain illustrative examples, a communication device includes a processor and a computer readable medium. The computer readable medium comprises processor executable instructions to cause the communication device to: receive a message from a second communication device, the message comprising a number of content elements, compare each of the content elements within the message to a set of restricted content elements, the set of restricted elements divided up into sub-sets according to category, withhold content elements that match the restricted content elements from display to a user of the communication device, and notify the user of the categories to which the content elements that match the restricted content elements belong.

According to certain illustrative examples, a method includes, with a server system, applying a filter function to a message being sent from a first communication device to a second communication device, the filter function finding at least one content element. The method further includes, with the server system, comparing the content element with a set of restricted content elements and withholding the message from communication in response to determining that the content element matches one of the restricted content elements.

### DESCRIPTION OF THE DRAWINGS

FIG. 1 is a diagram showing an illustrative server/client system, according to one example of principles described herein.

FIG. 2 is a diagram showing an illustrative communication of a message, according to one example of principles described herein.

FIG. 3 is a diagram showing an illustrative communication of messages, according to one example of principles described herein.

FIG. 4 is a diagram showing an illustrative communication of a message involving a chaperone, according to one example of principles described herein.

FIG. 5 is a diagram showing an illustrative communication of a replacement message, according to one example of principles described herein.

FIG. 6 is a flowchart showing an illustrative method for filtering content, according to one example of principles described herein.

FIG. 7 is a flowchart showing an illustrative method for filtering content, according to one example of principles described herein.

### DETAILED DESCRIPTION

The present specification discloses methods and systems for filtering content. According to certain illustrative examples, a filter function is applied to a message associated with a communication device. The message may be one that is being transmitted by the communication device or one that is being received by the communication device. The message includes a number of content elements. Content elements may include, for example, a string of text, an image, an audio clip, or a video clip.

Each content element is compared with a database that includes a set of restricted content elements. If a content element within the message matches a content element within the set of restricted content elements, then that message is withheld from being either transmitted or received. To make the comparison more efficient, various hash functions may be used by the filter function. Such hash functions will be described in further detail below.

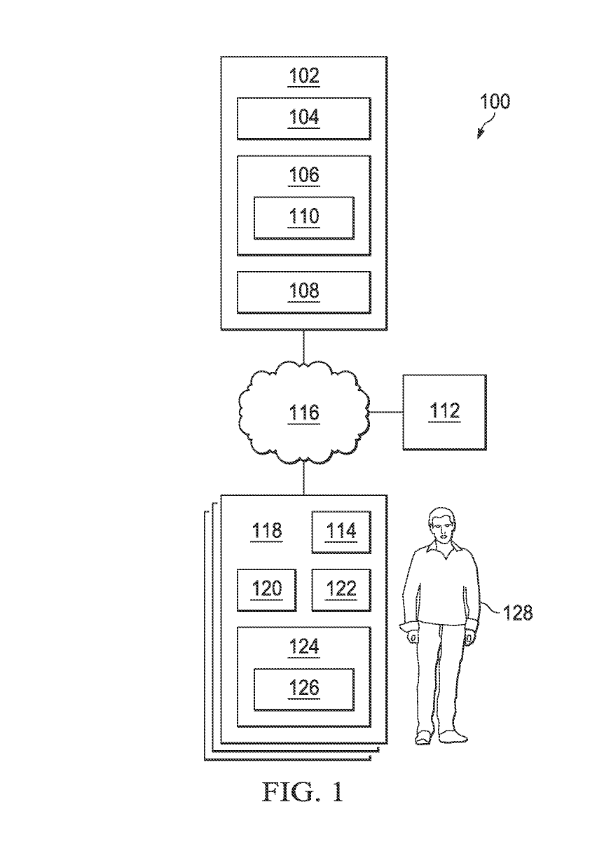

FIG. 1 is a diagram showing an illustrative server/client system 100. According to certain illustrative examples the system 100 includes a server 102 connected to a number of clients 118 via a network 116. The server 102 includes a processor 104, a memory 106, and a network interface 108. The server 102 is also communicably coupled to a database 112. The client 118 also includes a processor 122, a memory 124, and a network interface 120.

The processor 104 is used to execute computer readable instructions stored in memory 106. The processor 104 may be, for example, a central processing unit (CPU), a blade, an application specific integrated circuit (ASIC), a field-programmable gate array (FPGA), or another type of processor. Although a single processor 104 is illustrated within the server 102, multiple processors may be used according to particular needs, and reference to the processor 104 is meant to include multiple processors where applicable.

The memory 106 is a computer readable medium that may include any memory or database module. The memory 106 may take the form of volatile or non-volatile memory including, but not limited to, magnetic media, optical media, random access memory (RAM), read-only memory (ROM), removable media, or any other suitable local or remote and/or distributed memory and retrieved across a network, such as in a cloud-based computing environment. The memory 106 may store various pieces of data as well as various applications. One such application is a filter function for analyzing the content elements of messages.

The network interface 108 allows the server 102 to connect to other computing systems such as the database 112 or client systems 118 through the network 116. The network interface 108 may be embodied as hardware, software, or a combination of both. The network interface 108 may be communicably coupled with the network 116 through physical cable connections such as through Ethernet, coaxial, or fiber optic cables. The network interface 108 may also be communicably coupled with the network 116 through wireless mechanisms.

The server 102 may be any computer or processing device such as a mainframe, a blade server, general-purpose personal computer (PC), Macintosh®, workstation, UNIX-based computer, or any other suitable device. Additionally, the present disclosure contemplates computers other than general purpose computers, as well as computers without conventional operating systems. The term “computer” is intended to encompass a personal computer, workstation, network computer, mobile computing device, or any other suitable processing device. For example, while a server 102 is illustrated, the system 100 can be implemented using computers other than servers, as well as a server pool. The server 102 may be adapted to execute any operating system including z/OS, Linux-Intel® or Linux/390, UNIX, Windows Server®, or any other suitable operating system. According to one implementation, the server 102 may also include or be communicably coupled with a web server and/or an SMTP server.

The network 116 facilitates wireless or wireline communication between the server 102 and any other local or remote computer, such as the clients 118. The network 116 may be all or a portion of an enterprise or secured network. In one example, the network 114 may be a VPN between server 102 and client 124 across a wireline or wireless link. Such an example wireless link may be via 802.11a, 802.11b, 802.11g, 802.11n, 802.20, WiMax, and many others. The wireless link may also be via cellular technologies such as the 3rd Generation Partnership Project (3GPP) Global System for Mobile Communications (GSM), Universal Mobile Telecommunications System (UMTS), Long Term Evolution (LTE), etc. While illustrated as a single or continuous network, the network 116 may be logically divided into various sub-nets or virtual networks without departing from the scope of this disclosure, so long as at least portion of network 116 may facilitate communications between senders and recipients of requests and results. In other words, the network 116 encompasses any internal and/or external network, networks, sub-network, or combination thereof operable to facilitate communications between various computing components in the system 100. The network 116 may communicate, for example, Internet Protocol (IP) packets, Frame Relay frames, Asynchronous Transfer Mode (ATM) cells, voice, video, data, and other suitable information between network addresses. The network 116 may include one or more local area networks (LANs), radio access networks (RANs), metropolitan area networks (MANs), wide area networks (WANs), all or a portion of the global computer network known as the Internet, and/or any other communication system or systems at one or more locations.

A client device 118 may be a communication device such as a cellular phone, a tablet computer, smartphone, a laptop computer, etc. The client device 118 includes a network interface 120 similar to that of the server 102. The client device 118 also includes a processor 122, which is configured to process computer readable instructions for the client device 118. The client device also includes a memory 124 which may be used to store data as well as a filter application 126.

The client 128 may include a graphical user interface (GUI) 114 that is used to present and receive data to and from the user 128. The GUI 114 includes a graphical user interface operable to allow the user 128 to interface with at least a portion of the system 100 for any suitable purpose, including viewing, manipulating, editing, etc., graphic visualizations or user profile data. Generally, the GUI 114 provides the user 128 with an efficient and user-friendly presentation of data provided by or communicated within system 100. The GUI 114 may include a plurality of customizable frames or views having interactive fields, pull-down lists, and buttons operated by the user. In one implementation, the GUI 114 presents information associated with queries and buttons and receives commands from the user 128 via an input device.

It is understood that the terms graphical user interface and GUI may be used in the singular or in the plural to describe one or more graphical user interfaces and each of the displays of a particular graphical user interface. Therefore, the GUI 114 contemplates any graphical user interface, such as a generic web browser or touch screen, which processes information in the system 100 and efficiently presents the results to the user. The server 102 can accept data from the client 118 via the web browser (e.g., Microsoft® Internet Explorer or Mozilla® Firefox®) and return the appropriate HyperText Markup Language (HTML) or eXtensible Markup Language (XML) responses using the network 116. For example, the server 102 may receive a search request from the client 118 using a web browser or application-specific graphical user interface, and then execute the request to search for business entities that fulfill certain criteria and provide the search results to the GUI 114.

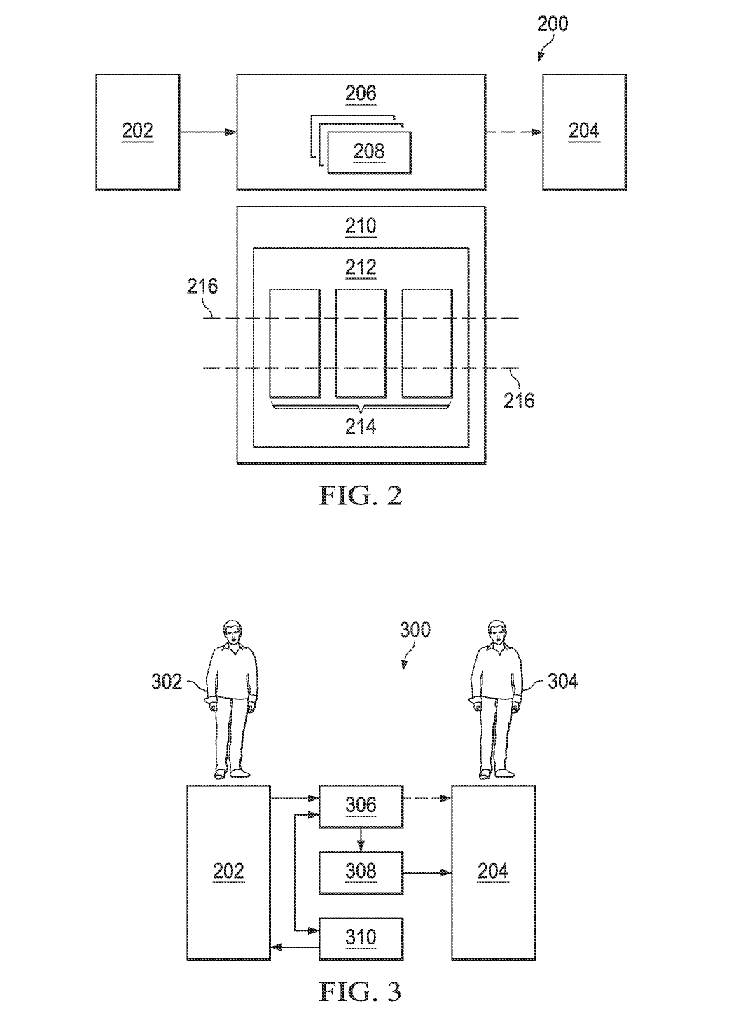

FIG. 2 is a diagram showing an illustrative communication 200 of a message 206. According to certain illustrative examples, a message 206 is sent from a first communication device 202 to a second communication device 204. Before being presented to a user of the second communication device 204, a filtering function is applied by a filtering function application to the message 206 to determine if the message 206 includes any content that should not be sent from the first communication device 202 or should not be delivered to the second communication device 204.

In one example, the filtering function application resides on a server system and the server applies the filter function to the message 206 at that server while the message 206 is en route to the second communication device 204. In one example, the filtering function application resides on the first communication device 202 and the first communication device 202 applies the filter function to the message 206 before being transmitted. In one example, the filtering function application resides on the second communication device 204 and the second communication device 204 applies the filter upon receipt of the message but before displaying the message to the user of the second communication device 204.

The message includes a number of content elements 208. A content element 208 may be, for example, a word within a piece of text, an audio clip within an audio file, a piece of an image, or a piece of a video frame from a video clip. The filter function analyzes each of those content elements 208 individually and compares them to a database of restricted content elements 210. Each content element 208 may be handled in a different manner depending on the type of content element 208. For example, if the content element 208 is a text based word, then that word can be compared with a list of restricted words within the restricted content element database 210. If the content element 208 is an audio clip, then that audio clip can be analyzed to determine what, if any, words are being communicated in that audio clip. Those words can then be compared with the restricted words in the restricted content element database 210.

In the case where the content element 208 is an image or video clip, then certain functions may be applied in order to determine whether those images or video clips include restricted content elements. For example, an image may be analyzed to find any words within the image. Those words may then be compared with the list of restricted words in the restricted content element database 210. Additionally or alternatively, an image may be analyzed for particular types of content. For example, various functions can be applied that analyze the key features, shading, and saliency features of the image. Various hash functions may then be applied which are designed to compare the image efficiently with restricted elements. For example, the functions applied to the image may create a hash value that indicates a feature within the image. The hash value may indicate certain characteristics such as skin tone, shape configuration, body features, and nudity. The hash value may then be compared with hash values in the restricted content element database that indicate inappropriate features. For example, if the image includes nude elements, then a hash value indicating nude elements can be compared with the database of restricted content elements for images and if there is a match, then it can be determined that the message includes restricted content.

In the case of video clips, various frames within the video clip can be analyzed in a manner similar to that of images. In some cases, frames may be selected at random for analysis. In some cases, every nth frame may be analyzed for inappropriate content.

The restricted content element database 210 may include different categories 214 for each type of content element 208. For example, for words or audio clips, the content element database 210 may include categories 214 for profanity, drug related words, and sex related words. For images and videos, the database 210 may include categories 214 for sex, nudity, violence, language, and drug use. Each category 214 may be divided up into different levels 216 for different audiences. Different levels define how strictly content is filtered by the filter function application. Each user can select his or her preferences as to what type of content should be restricted. For example, a user may not mind mild profanity but may wish to avoid words that are considered by community standards to be extremely vulgar. In some cases, a user may select with great specificity which content is to be restricted or allowed. Specifically, a user may select specific words for restriction. Additionally, a user may select specific types of nudity to be restricted.

Based on the user preference settings for a particular user, a set 212 of restricted content elements is defined. It is that set 212 of restricted content elements with which the content elements 208 of the message 206 are compared. Thus, each user has a customized filter function applied. The user may customize the set 212 of restricted content elements through the filter function application. The filter function application may be stored and executed on the user's communication device 202, 204. Alternatively, the filter function application may be a web-based application. In such a case, the user may log in to an account and adjust the user settings accordingly. The set of restricted content elements may be a set of default content elements. A user may wish to add restricted content elements. For example, a user may wish to filter certain words which are not typically deemed obscene by community standards.

FIG. 3 is a diagram showing an illustrative communication 300 of messages. According to certain illustrative examples, the manner in which restricted content is handled may vary. For example, the filter function application may be configured to send a notification message 308 to the recipient 304 of a flagged message 306. Additionally or alternatively, the filter function application may be configured to send a reply message 310 back to the sender 302 of a flagged message 306.

A flagged message 306 is one that includes at least one content element that matches a content element within the set of restricted content elements. In one example, the recipient 304 of the flagged message 306 is provided with a notification message 308 indicating that he or she has been sent a flagged message 306. The notification message 308 may indicate the sender 302 of the flagged message 306. The notification message 308 may also indicate why the flagged message 306 was flagged. For example, the recipient 304 may receive a notification message 308 stating “Incoming message flagged: profanity in text.” Thus, the recipient 304 knows that the message was not delivered due to at least one profane word within the text of the message. In some cases, the recipient 304 may have the authority to allow delivery of the message anyway. For example, the recipient 304 may indicate through his or her device that he or she wishes to receive the message regardless of the flagged content. Alternatively, the recipient 304 may choose to ignore the message.

In some cases, the sender 302 of a flagged message 306 may receive a reply message 310 indicating that the flagged message 306 was flagged and not delivered. The reply message 310 may also indicate the reason why the message was flagged. For example, the reply message 310 may state “Message not delivered: nudity in image detected.” Thus, the sender 302 knows that he or she is unable to send that type of message to the recipient 304.

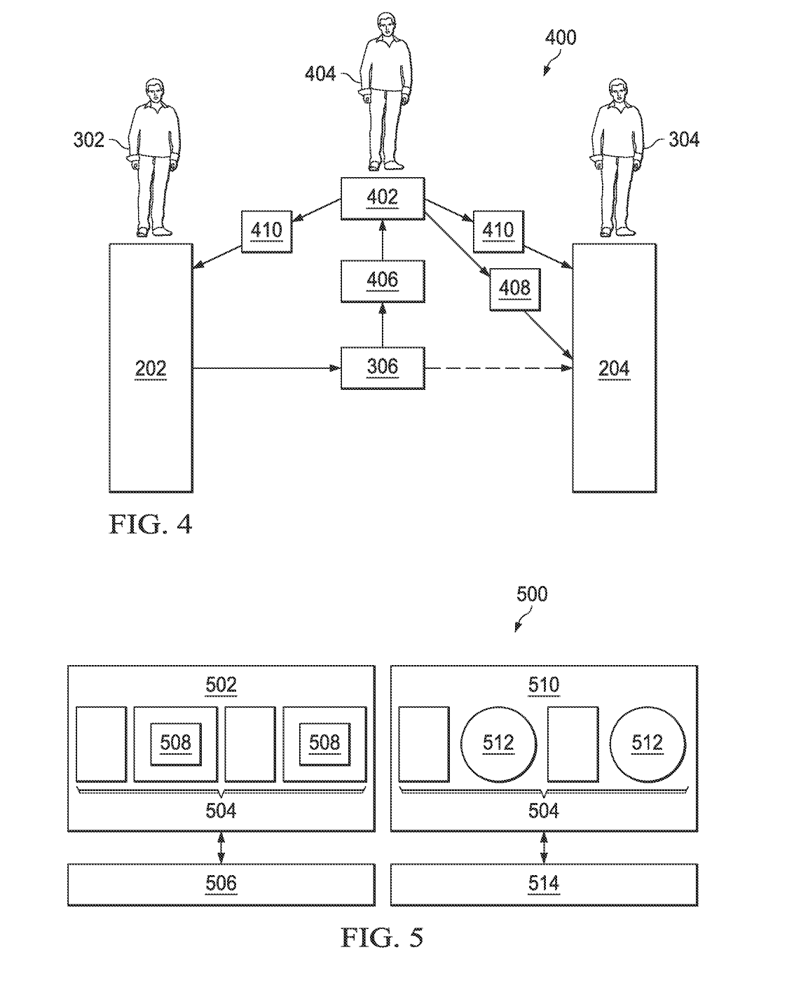

FIG. 4 is a diagram showing an illustrative communication 400 of a message involving a chaperone 404. According to certain illustrative examples, when a message is flagged, a chaperone 404 is notified. The chaperone 404 may be, for example, a parent or a manager of an organizational entity. In some cases, multiple chaperones may be associated with a particular account. The chaperone 404 may have the authority to authorize or forbid transmission of the flagged message to a recipient 304. The chaperone 404 may also have the authority to edit the flagged message 306 before that message is provided to the recipient 304.

A particular communication device may be registered with a particular account. That account may be assigned one or more chaperones 404. For example, a family cell phone plan may designate the parents as chaperones 404 for the communication devices assigned to a number of children. The chaperone 404 in such cases can set the preferences for each child's communication device. In some cases, the level of restriction for a particular child's communication device may be based on that child's age. In a further example, a corporate cell phone plan may assign a particular administrator within the corporation as the chaperone 404. That chaperone can then set the restriction preferences for each employee's communication device.

In one example, in the case of a flagged message 306, an alert message is sent to a chaperone device 402. The chaperone device 402 may be any computing device such as a cell phone, tablet computer, or other type of personal computer. The alert message may be in the form of a text message or email message. The alert message 406 may indicate both the sender 302 and the recipient 304 of the flagged message 306. The alert message 406 may also indicate to the chaperone 404 why the flagged message was flagged. The chaperone 404 may then have the authority to allow the flagged message to be delivered anyway. In some cases, a flagged message may have to be approved by multiple chaperones 404. For example, both parents may have to approve a flagged message before it can be sent to a child.

The chaperone 404 may also choose to disallow the message from being received by the recipient 394. In such a case, a rejection message 410 may be sent to the sender 302, the recipient 304, or both. The rejection message 410 indicates that a message communicated between the sender 302 and the recipient 304 was flagged, sent to the chaperone 404 and prevented from delivery. In some cases, the chaperone may forward the flagged message to a chaperone for the sender of the flagged message if the sender 302 is associated with a different account. For example, a parent may forward the flagged message to a parent of the sender.

In one example, the chaperone 404 may have the ability to edit the flagged message 306 before allowing it to be delivered to the recipient 304. For example, the chaperone 404 may replace profane words with suitable replacements. Alternatively, the chaperone 404 may censor certain portions of an image or video before allowing the message to be delivered. The edited message 408 may then be sent to the recipient. Additionally, the sender 302 may receive a notification indicating that the message was edited before being delivered.

FIG. 5 is a diagram showing an illustrative communication 500 of a replacement message 510. According to certain illustrative examples, a flagged message may be automatically edited. The content elements 504 within the message that match restricted content elements may be replaced with replacement elements 512 that are deemed suitable replacements.

According to certain illustrative examples, the content elements 504 of the original message 502 are compared with the restricted content elements 506 in the restricted content element database 506. For each matched content element 508 (i.e., a content element 504 that matches a restricted content element 506), a replacement database is searched to see if there is a suitable replacement element 512 for that matched element 508.

If the matched content element 508 is a word, then a suitable replacement element may be a less profane version of that word. If the matched content element 508 is an audio clip of a restricted word, then the replacement element may be a pre-recorded less profane version of that word. If the matched content element 508 is a piece of an image, then a black or blurred region may replace that piece of the image. Alternatively, a standard image may replace the matched content element 508 image. For example, a general stick figure image may replace a nude element detected within the image. In some cases, the replacement process may simply redact the matched content elements 508. This may be done, for example, if no suitable replacement content element 512 is found.

The replacement process may be performed automatically without any input from the sender, recipient, or a chaperone. In some cases, a notification message may be sent to the sender indicating that his or her message was automatically revised before delivery. The notification message may indicate the reasons for the replacement.

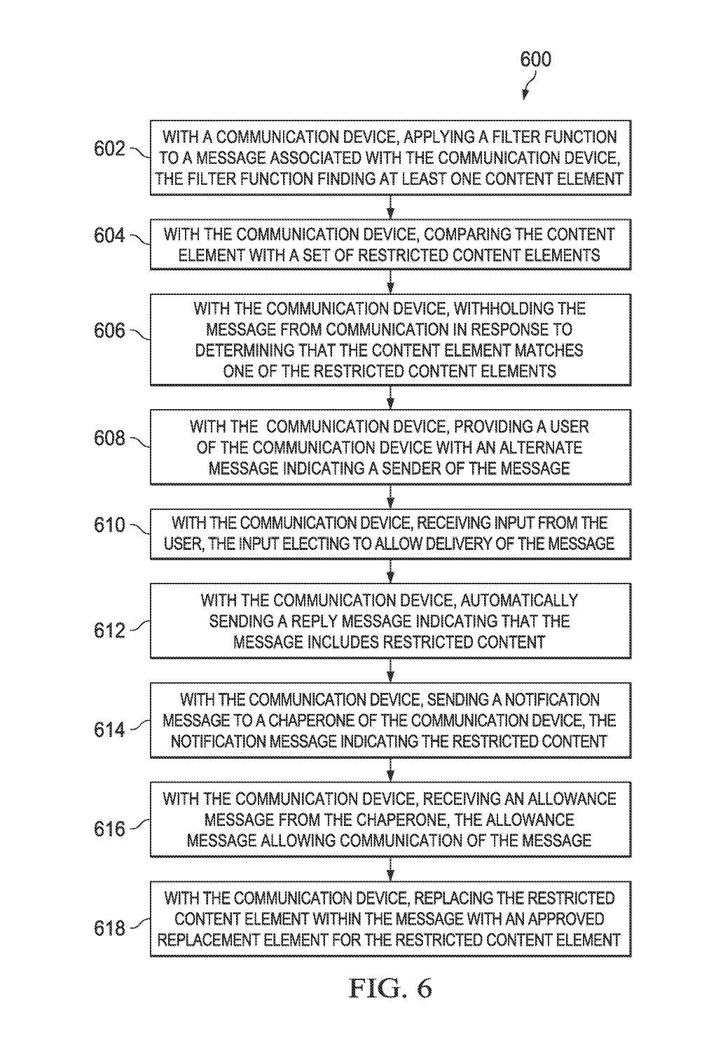

FIG. 6 is a flowchart showing an illustrative method 600 for filtering content. According to certain illustrative examples, the method 600 includes, with a communication device, applying 602 a filter function to a message associated with the communication device, the filter function finding at least one content element. The method further includes, with the communication device, comparing 604 the content element with a set of restricted content elements and withholding 606 the message from communication in response to determining that the content element matches one of the restricted content elements.

The method further includes, with the communication device, providing 608 a user of the communication device with an alternate message indicating a sender of the message. The method further includes, with the communication device, receiving 610 input from the user, the input electing to allow delivery of the message. The method further includes, with the communication device, automatically sending 612 a reply message to a sender of the message, the reply message indicating that the message includes restricted content. The method further includes, sending 614 a notification message to a chaperone of the communication device, the notification message indicating to the chaperone the restricted content element. The method further includes, receiving 616 an allowance message from the chaperone, the allowance message allowing communication of the message. The method further includes, replacing 618 the restricted content element within the message with an approved replacement element for the restricted content element.

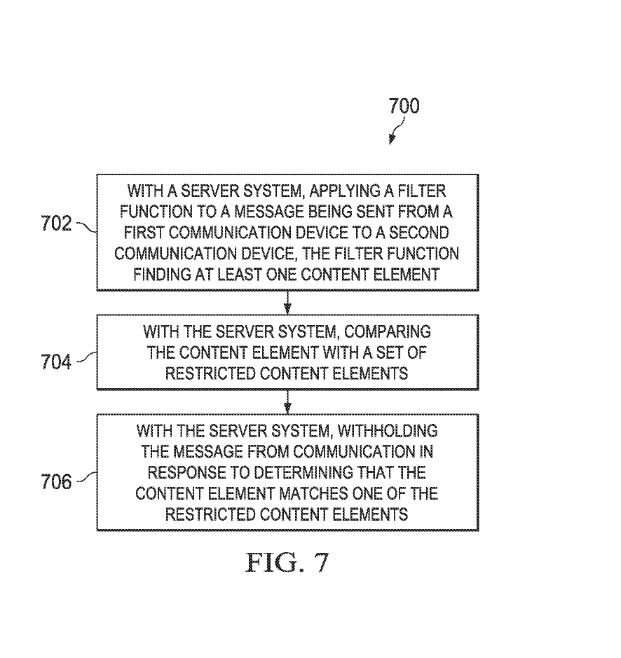

FIG. 7 is a flowchart showing an illustrative method for filtering content. According to certain illustrative examples, the method includes, with a server system, applying 702 a filter function to a message being sent from a first communication device to a second communication device, the filter function finding at least one content element. The method further includes, with the server system, comparing 704 the content element with a set of restricted content elements and withholding 706 the message from communication in response to determining that the content element matches one of the restricted content elements.

What is claimed is:

1. A method for filtering content with a communication device, the method comprising:
with the communication device, applying a filter function to a message associated with the communication device, the filter function finding at least one content element;
with the communication device, comparing the content element with a set of restricted content elements;
with the communication device, withholding the message from communication in response to determining that the content element matches one of the restricted content elements.

2. The method of claim 1, wherein the message is being received by the communication device from a second communication device.

3. The method of claim 2, further comprising, with the communication device, providing a user of the communication device with an alternate message indicating a sender of the message.

4. The method of claim 3, wherein the alternate message further indicates to the recipient a category associated with the one of the restricted content elements.

5. The method of claim 2, further comprising, with the communication device, receiving input from the user, the input electing to allow delivery of the message.

6. The method of claim 2, further comprising, with the communication device, automatically sending a reply message to a sender of the message, the reply message indicating that the message includes restricted content.

7. The method of claim 1, further comprising, with the communication device, sending a notification message to a chaperone of the communication device, the notification message indicating to the chaperone the restricted content element.

8. The method of claim 7, further comprising, with the communication device, receiving an allowance message from the chaperone, the allowance message allowing communication of the message.

9. The method of claim 8, wherein the message is edited by the chaperone before being allowed communication.

10. The method of claim 1, further comprising, with the communication device, replacing the restricted content element within the message with an approved replacement element for the restricted content element.

11. The method of claim 1, wherein restricted content elements within the set of restricted content elements are based on preferences set for a user of the communication device.

12. The method of claim 1, wherein the message is being sent by the communication device to a second communication device.

13. The method of claim 1, wherein applying the filtering function comprises analyzing an image to look for text within the image.

14. A server system comprising:
a processor; and
a computer readable medium;
wherein, computer readable medium comprises processor executable instructions to cause the server to:
receive a message from a first communication device, the message to be sent to a second communication device;
compare a content element within the message with a set of restricted content elements; and
withhold the message from the second communication device in response to finding a match between the content element and one of the restricted content elements.

15. The server system of claim 14, wherein the processor executable instructions are further to cause the server to provide a user of the second communication device with an alternate message indicating the first communication device as sender of the message.

16. The server system of claim 14, wherein the processor executable instructions are further to cause the server to:
forward the message to a chaperone of an account associated with one of: the first communication device and the second communication device; and
sending an approved version of the message to the second communication device in response to receiving approval from the chaperone.

17. The server system of claim 14, wherein the processor executable instructions are further to cause the server to automatically replace the restricted content element within the message with a pre-defined replacement content element.

18. The server system of claim 14, wherein the message comprises one of: a Short Message Service (SMS) message, a Multimedia Messaging Service (MMS) message, and an email message and the content element comprises at least one of: a text string, an image, an audio file, and a video file.

19. The server system of claim 14, wherein the set of restricted content elements is divided into sub-sets corresponding to categories, the categories including at least sex, violence, language, drug use.

20. A communication device comprising:
a processor; and
a computer readable medium;
wherein, computer readable medium comprises processor executable instructions to cause the communication device to:
receive a message from a second communication device, the message comprising a number of content elements;
compare each of the content elements within the message to a set of restricted content elements, the set of restricted elements divided up into sub-sets according to category;
withhold content elements that match the restricted content elements from display to a user of the communication device; and
notify the user of the categories to which the content elements that match the restricted content elements belong.

21. A method for filtering content, the method comprising:
with a server system, applying a filter function to a message being sent from a first communication device to a second communication device, the filter function finding at least one content element;
with the server system, comparing the content element with a set of restricted content elements; and
with the server system, withholding the message from communication in response to determining that the content element matches one of the restricted content elements.

22. The method of claim 21, further comprising, with the server system, transmitting to the second communication device, an alternate message indicating a sender of the message.

23. The method of claim 22, wherein the alternate message further indicates to the recipient a category associated with the one of the restricted content elements.

24. The method of claim 21, further comprising, with the server system, receiving an indication from the user that the user elects to allow delivery of the message.

25. The method of claim 21, further comprising, with the server system, automatically sending a reply message to the first communication device, the reply message indicating that the message includes restricted content.

26. The method of claim 21, further comprising, with the server system, sending a notification message to a chaperone of one of the communication devices, the notification message indicating to the chaperone the restricted content element.

27. The method of claim 26, further comprising, with the server system, receiving an allowance message from the chaperone, the allowance message allowing communication of the message.

28. The method of claim 27, wherein the message is edited by the chaperone before being allowed communication.

29. The method of claim 21, further comprising, with the server system, replacing the restricted content element within the message to an approved replacement element for the restricted content element.

30. The method of claim 21, wherein restricted content elements within the set of restricted content elements are based on preferences set for a user of one of the communication devices.

31. The method of claim 21, wherein applying the filtering function comprises analyzing an image to look for text within the image.
